(19) United States
(12) Patent Application Publication
(10) Pub. No.: US 2025/0039254 A1
(43) Pub. Date: Jan. 30, 2025

(54) DATA TRANSMISSION METHOD AND APPARATUS, ELECTRONIC DEVICE, AND STORAGE MEDIUM

(71) Applicant: TENCENT TECHNOLOGY (SHENZHEN) COMPANY LIMITED, Shenzhen (CN)

(72) Inventors: Bin LAN, Shenzhen (CN); Siyong LIN, Shenzhen (CN)

(21) Appl. No.: 18/914,386

(22) Filed: Oct. 14, 2024

Related U.S. Application Data
(63) Continuation of application No. PCT/CN2023/124080, filed on Oct. 11, 2023.

(30) Foreign Application Priority Data
Nov. 16, 2022 (CN) 202211436459.7

(51) Int. Cl. H04L 65/65

(52) U.S. Cl. CPC H04L 65/65

(57) ABSTRACT

This application provides a data transmission method and apparatus, an electronic device, and a storage medium, and relates to the field of data transmission technologies. The method includes allocating a first data stream of a first service data stream transmitted on the first link and a second data stream of the first service data stream transmitted on the second link, the first link and the second link connecting the first apparatus and a second apparatus, a physical address of the first apparatus corresponding to the first link being different from a physical address of the first apparatus corresponding to the second link, and the first link and the second link being links of a quick user datagram protocol Internet connection (QUIC) protocol; transmitting the first data stream to the second apparatus; and transmitting the second data stream to the second apparatus.

### RELATED APPLICATIONS

This application is a continuation of PCT Application No. PCT/CN2023/124080, filed on Oct. 11, 2023, which claims priority to Chinese Patent Application No. 202211436459.7, filed with the China National Intellectual Property Administration on Nov. 16, 2022 and entitled “DATA TRANSMISSION METHOD AND APPARATUS, ELECTRONIC DEVICE, AND STORAGE MEDIUM”, which are incorporated herein by reference in their entirety.

### FIELD OF THE TECHNOLOGY

This application relates to the communication field, and specifically, to a data transmission method and apparatus, an electronic device, and a storage medium.

### BACKGROUND OF THE DISCLOSURE

A quick user datagram protocol Internet connection (QUIC) protocol is a low-latency Internet transport layer protocol based on a user datagram protocol (UDP) and has certain advantages compared with another protocol. The QUIC protocol works at an application layer and does not require kernel support. The QUIC protocol can reduce network latency while ensuring reliability, and has improved congestion control and better multiplexing. However, a performance bottleneck of a physical link cannot be overcome by using a QUIC path established based on the QUIC protocol. Under the constraints of physical link performance, a high transmission bandwidth may not be achieved by using a single QUIC path.

With the development of network technologies, connection methods between devices are becoming more diverse, and there is a plurality of connection methods between one device and another device. How to apply the QUIC protocol to the plurality of connection methods between the devices and establish a plurality of physical links between the devices to transmit data, increase a bandwidth of data transmission between the devices, and improve user experience is an urgent problem to be solved.

### SUMMARY

Embodiments of this application provide a data transmission method and apparatus, an electronic device, and a storage medium, and a plurality of physical links are established between devices by applying a QUIC protocol, so as to transmit data, thereby increasing a bandwidth of data transmission between the devices and improving user experience.

The first aspect of this application provides a data transmission method, applied to a first apparatus. The method includes allocating, based on a bandwidth of a first link and a bandwidth of a second link, a first data stream of a first service data stream transmitted on the first link and a second data stream of the first service data stream transmitted on the second link, the first link and the second link connecting the first apparatus and a second apparatus, a physical address of the first apparatus corresponding to the first link being different from a physical address of the first apparatus corresponding to the second link, and the first link and the second link being links of a quick user datagram protocol Internet connection (QUIC) protocol; transmitting the first data stream to the second apparatus based on a first transmitting stream of the first link; and transmitting the second data stream to the second apparatus based on a first transmitting stream of the second link.

Another aspect of this application provides a data transmission method, applied to a second apparatus. The method includes receiving, based on a first receiving stream of a first link, a first data stream transmitted by a first apparatus; receiving, based on a first receiving stream of a second link, a second data stream transmitted by the first apparatus, the first link and the second link connecting the first apparatus and the second apparatus, a physical address of the first apparatus corresponding to the first link being different from a physical address of the first apparatus corresponding to the second link, and the first link and the second link being links supporting a quick user datagram protocol Internet connection (QUIC) protocol; and determining a first service data stream based on the first data stream and the second data stream.

Another aspect of this application provides a data transmission method, applied to a first apparatus. The method includes transmitting a request to link message to a second apparatus, the request to link message comprising a first connection identification, the first connection identification being a connection identification of a first transmitting stream of a first link, and the request to link message further comprising information indicating whether the first apparatus has a capability supporting QUIC protocol-based multipath and/or a quantity of QUIC protocol-based multipaths supported by the first apparatus; receiving a feedback message transmitted by the second apparatus, the feedback message comprising a second connection identification, the second connection identification being a connection identification of a second transmitting stream of the first link, and the feedback message further comprising information indicating whether the second apparatus has a capability supporting the QUIC protocol-based multipath and/or a quantity of QUIC protocol-based multipaths supported by the second apparatus; and generating parameter information of the first link based on the feedback message, the parameter information of the first link comprising the first connection identification, the second connection identification, and a link identification of the first link, and the link identification of the first link being a first link identification.

According to the foregoing technical solutions, the first apparatus allocates, based on the bandwidth of the first link and the bandwidth of the second link, the first data stream of the first service data stream transmitted on the first link and the second data stream of the first service data stream transmitted on the second link. As such, data transmission between different apparatuses via a plurality of links is implemented to break the performance bottleneck of a single physical link. In addition, data streams transmitted on different links are allocated based on bandwidths of links between the different apparatuses, and data streams that need to be transmitted are properly allocated to reduce link data congestion. Then, the first apparatus transmits the first data stream to the second apparatus based on the first transmitting stream of the first link, and the first apparatus transmits the second data stream to the second apparatus based on the first transmitting stream of the second link. As such, data transmission of a first service between the first apparatus and the second apparatus is performed via the first link and the second link supporting the QUIC protocol, so that network transmission speed is greatly improved, and user experience is improved.

### BRIEF DESCRIPTION OF THE DRAWINGS

To describe the technical solutions in embodiments of the present disclosure more clearly, the following briefly describes the accompanying drawings required for describing embodiments. The accompanying drawings in the following description show merely some embodiments of the present disclosure, and a person of ordinary skill in the art may still derive other drawings from these accompanying drawings without creative efforts.

FIG. 1 is a schematic diagram of a system architecture included in an embodiment of this application.

FIG. 2 is a schematic flowchart of a data transmission method according to an embodiment of this application.

FIG. 3 is a schematic block diagram of two QUIC links between a first apparatus and a second apparatus according to an embodiment of this application.

FIG. 4 is another schematic block diagram of two QUIC links between a first apparatus and a second apparatus according to an embodiment of this application.

FIG. 5 is a schematic flowchart of a data transmission method according to an embodiment of this application.

FIG. 6 is a schematic flowchart of a method for establishing multiple QUIC paths according to an embodiment of this application.

FIG. 7 is a schematic flowchart of a data transmission method according to an embodiment of this application.

FIG. 8 is a schematic flowchart of a data transmission method according to an embodiment of this application.

FIG. 9 is a schematic diagram of an experimental scenario involved in an embodiment of this application.

FIG. 10 is a schematic diagram of link performance parameters of a single QUIC path and multiple QUIC paths according to an embodiment of this application.

FIG. 11 is a schematic block diagram of an apparatus according to an embodiment of this application.

FIG. 12 is a schematic block diagram of an apparatus according to an embodiment of this application.

FIG. 13 is a schematic block diagram of an electronic device according to an embodiment of this application.

### DESCRIPTION OF EMBODIMENTS

The following clearly and completely describes the technical solutions in embodiments of the present disclosure with reference to the accompanying drawings in embodiments of the present disclosure. The described embodiments are merely some of embodiments of the present disclosure rather than all embodiments. All other embodiments obtained by a person of ordinary skill in the art based on embodiments of the present disclosure without creative efforts shall fall within the protection scope of the present disclosure.

In this specification, claims, and accompanying drawings of the present disclosure, the terms “first”, “second”, and the like are intended to distinguish similar objects but do not necessarily indicate a specific order or sequence. Data used As such is interchangeable in a proper case, so that embodiments of the present disclosure described herein can be implemented in an order other than those illustrated or described herein. Moreover, the terms “include”, “have” and any other variants are intended to cover the non-exclusive inclusion, for example, a process, method, system, product, or server that includes a list of operations or units is not necessarily limited to those expressly listed operations or units, but may include other operations or units not expressly listed or inherent to such a process, method, product, or device.

Technical solutions in embodiments of this application are described below with reference to the accompanying drawings in embodiments of this application.

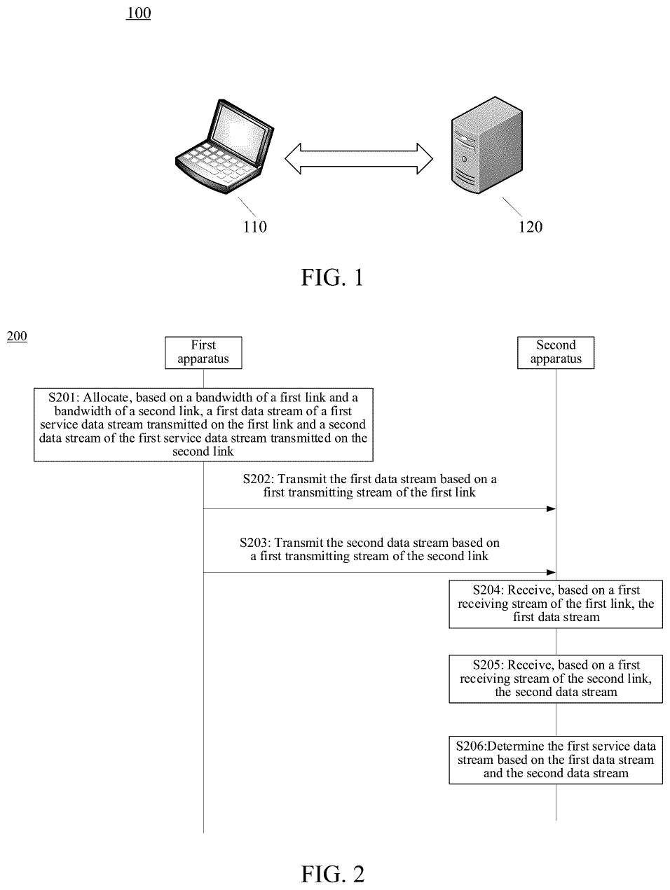

FIG. 1 is a schematic diagram of a system architecture 100 in an embodiment of this application. As shown in FIG. 1, the system architecture 100 includes a client device 110 and a server side device 120. The client device 110 and the server side device 120 can communicate and interact with each other in a wired or wireless manner.

The client device 110 supports a QUIC protocol. The client device 110 may be a wireless terminal device or a wired terminal device. The wireless terminal device may be a device with a wireless transceiver function, and may be a smart phone, a tablet computer (Pad), a smart speaker, a smart watch, a laptop, a virtual reality (VR) user device, an augmented reality (AR) user device, an on-board device, a wearable device, or the like. The wired terminal device may be a desktop computer, a server, or the like, but is not limited thereto. A terminal may be directly or indirectly connected to a server in a wired or wireless communication manner. This is not limited in this application.

The server side device 120 also supports the QUIC protocol. The server side device 120 may be an independent physical server, a server cluster or a distributed system including a plurality of physical servers, or a cloud server that provides basic cloud computing services such as a cloud service, a cloud database, cloud computing, a cloud function, cloud storage, a network service, cloud communication, a middleware service, a domain name service, a security service, CDN, and a big data and artificial intelligence platform.

The QUIC protocol is a communication protocol based on a user datagram protocol (UDP) and has certain advantages compared with another protocol. The QUIC protocol works at an application layer and does not require kernel support. The QUIC protocol reduces a network latency while ensuring reliability, has advantages of better congestion control, better multiplexing, link migration, and the like, and improves performance of a single physical path. Therefore, the QUIC protocol is widely used in the Internet field.

A QUIC data packet is divided into a header and a data part. The header is transmitted in plaintext and includes flags and a connection ID (CID). The CID may be configured for connection migration. QUIC Version is a version number of QUIC. Packet Number is a packet number configured for ensuring reliable transmission. The data part is transmitted in ciphertext and includes some data frames including a plurality of frame types.

The client device 110 shown in FIG. 1 establishes a network connection with the server side device 120, and the client device 110 may view live streaming content by using the server side device 120. In existing streaming media transmission scenarios such as a live stream pushing scenario, a stream pulling scenario, a video on demand scenario, and a content delivery network (CDN) scenario, a large quantity of network resources, for example, high requirements on a network bandwidth and network transmission speed, are often consumed. Currently, in the streaming media transmission scenarios, the QUIC protocol is used to establish network connections between devices. Although network latency can be reduced to some extent, a performance bottleneck of a physical link cannot be overcome. Under constraints of physical link performance, a single QUIC path may be incapable of achieving a high transmission bandwidth, consequently, user experience is still poor.

With the development of network technologies, the network access method of the client device is becoming more diverse. From one terminal to another terminal, there are a plurality of links such as wireless fidelity (Wi-Fi)/4G/5G, which provides a physical basis for the implementation of multipath. How to make full use of the plurality of links for parallel transmission to increase the transmission bandwidth and use the plurality of links as link backup to improve link stability is of great significance for the streaming media scenarios that require a large quantity of network resources for transmission. In the scenarios, if the QUIC protocol can be used to establish the plurality of physical links, in multipath, a plurality of paths with limited capabilities can be superimposed to obtain a logical path with a higher capability. This can greatly improve the transmission speed and increase the network bandwidth, thereby meeting requirements on network resources in the streaming media scenarios.

Therefore, this application provides a data transmission method. According to the method, links, namely a first link and a second link, supporting the QUIC protocol are established between the client device and the server side device. The client device may allocate, based on a bandwidth of the first link and a bandwidth of the second link, a first data stream of a first service data stream transmitted on the first link and a second data stream of the first service data stream transmitted on the second link, and then transmit the first data stream to the server side device based on a first transmitting stream of the first link, and transmit the second data stream to the server side device based on a first transmitting stream of the second link. Data transmission between the client device and the server side device is performed via the first link and the second link that support the QUIC protocol, so that the network bandwidth and network transmission speed are greatly increased, and user experience is improved.

The following describes the method provided in embodiments of this application with reference to the accompanying drawings.

FIG. 2 is a schematic flowchart of a data transmission method 200 according to an embodiment of this application. The method 200 may be performed by any electronic device having a data processing capability. For example, the electronic device may be implemented as a server or a computer. An example in which the electronic device is a first apparatus is used for description. As shown in FIG. 2, the method 200 may include operations 201 to 206.

The specific operations of the method 200 are described below.

S210: The first apparatus allocates, based on a bandwidth of a first link and a bandwidth of a second link, a first data stream of a first service data stream transmitted on the first link and a second data stream of the first service data stream transmitted on the second link, the first link and the second link connecting the first apparatus and a second apparatus, a physical address of the first apparatus corresponding to the first link being different from a physical address of the first apparatus corresponding to the second link, and the first link and the second link being links supporting a quick user datagram protocol Internet connection (QUIC) protocol.

S220: The first apparatus transmits the first data stream to the second apparatus based on a first transmitting stream of the first link.

S230: The first apparatus transmits the second data stream to the second apparatus based on a first transmitting stream of the second link.

S240: The second apparatus receives, based on a first receiving stream of the first link, the first data stream transmitted by the first apparatus.

S250: The second apparatus receives, based on a first receiving stream of the second link, the second data stream transmitted by the first apparatus.

S260: The second apparatus determines the first service data stream based on the first data stream and the second data stream.

In the method 200, two links, namely the first link and the second link, supporting the QUIC protocol are established between the first apparatus and the second apparatus. The first apparatus allocates, based on the bandwidth of the first link and the bandwidth of the second link, the first data stream of the first service data stream transmitted on the first link and the second data stream of the first service data stream transmitted on the second link. As such, data transmission between different apparatuses via a plurality of links is implemented, so that a performance bottleneck of a single physical link can be overcome. In addition, data streams transmitted on different links are allocated based on bandwidths of the links between the different apparatuses, and data streams that need to be transmitted are properly allocated, so that a phenomenon of link data congestion is reduced. Then, the first apparatus transmits the first data stream to the second apparatus based on the first transmitting stream of the first link, and the first apparatus transmits the second data stream to the second apparatus based on the first transmitting stream of the second link. As such, data transmission of a first service between the first apparatus and the second apparatus is performed via the first link and the second link supporting the QUIC protocol, so that network transmission speed is greatly improved, and user experience is improved.

Establishing a multipath QUIC link can further improve system stability. For example, when the first link fails, the second link can continue to be used for data transmission between the first apparatus and the second apparatus.

To better describe method 200, the two QUIC links established between the first apparatus and the second apparatus are described below. The two QUIC links established between the first apparatus and the second apparatus are the first link and the second link respectively. A data stream used by the QUIC protocol is generally a unique flow. Therefore, the first link includes the first transmitting stream and a second transmitting stream. The first transmitting stream is used by the first apparatus to transmit data to the second apparatus. Correspondingly, the second apparatus receives, through the first transmitting stream, the data transmitted by the first apparatus. The first transmitting stream may also be referred to as the first receiving stream for the second apparatus. The second transmitting stream is used by the second apparatus to transmit data to the first apparatus. Correspondingly, the first apparatus receives, through the second transmitting stream, the data transmitted by the second apparatus. The second transmitting stream may also be referred to as a second receiving stream for the first apparatus. Similarly, the second link includes the first transmitting stream and the second transmitting stream. The first transmitting stream is used by the first apparatus to transmit data to the second apparatus. Correspondingly, the second apparatus receives, through the first transmitting stream, the data transmitted by the first apparatus. The first transmitting stream may also be referred to as the first receiving stream for the second apparatus. The second transmitting stream is used by the second apparatus to transmit data to the first apparatus. Correspondingly, the first apparatus receives, through the second transmitting stream, data transmitted by the second apparatus. The second transmitting stream may also be referred to as the second receiving stream for the first apparatus. The first link and the second link are marked with a unique flow identification (UID), the first link is marked with a first UID, and the second link is marked with a second UID. A connection identification of the first transmitting stream of the first link is a first connection identification (CID), a connection identification of a second transmitting stream of the first link is a second CID, a connection identification of the first transmitting stream of the second link is a third CID, and a connection identification of a second transmitting stream of the second link is a fourth CID.

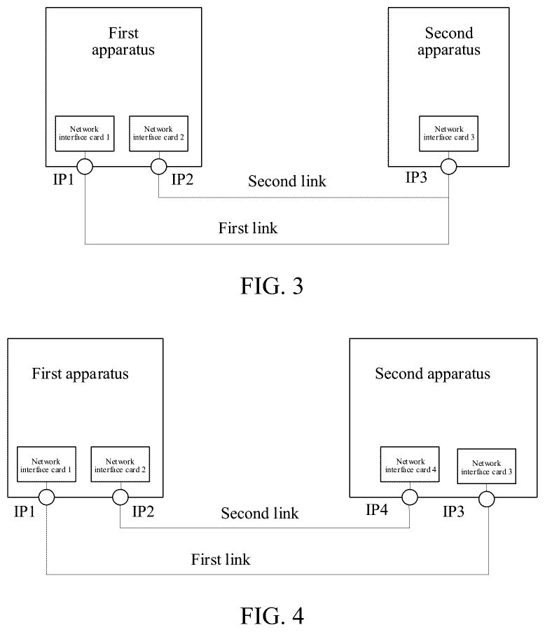

To establish the two QUIC links between the first apparatus and the second apparatus, the first apparatus needs to have at least two available physical links. For example, two network interface cards, namely network interface card 1 and network interface card 2, are installed in the first apparatus, an IP address of network interface card 1 is IP1, and an IP address of network interface card 2 is IP2. The second apparatus has at least one available physical link. For example, one network interface card, namely network interface card 3, is installed in the second apparatus, and an IP address of network interface card 3 is IP3. FIG. 3 is a schematic block diagram of two QUIC links between the first apparatus and the second apparatus according to an embodiment of this application.

In one embodiment, a physical address of the second apparatus corresponding to the first link is different from a physical address of the second apparatus corresponding to the second link.

Specifically, two different network interface cards, such as network interface card 3 and network interface card 4, may alternatively be installed in the second apparatus, the IP address of network interface card 3 is IP3, and an IP address of network interface card 4 is IP4. The first link is a link from network interface card 1 to network interface card 3, and the second link is a link from network interface card 2 to network interface card 4. FIG. 4 is another schematic block diagram of two QUIC links between the first apparatus and the second apparatus according to an embodiment of this application.

In one embodiment, when the first apparatus allocates the first service data stream to the first link and the second link for simultaneous transmission, to determine the first service data stream when the second apparatus receives the first data stream of the first link and the second data stream of the second link, that is, to ensure orderliness of data, the first apparatus may add offsets to data packets respectively corresponding to the first data stream and the second data stream. The offsets indicate positions of the data packets to which the offsets belong in an original data packet, that is, the first service data stream. The second apparatus sorts the data packets respectively corresponding to the first data stream and the second data stream based on offset fields in the data packets respectively corresponding to the first data stream and the second data stream. Therefore, the first service data stream is determined.

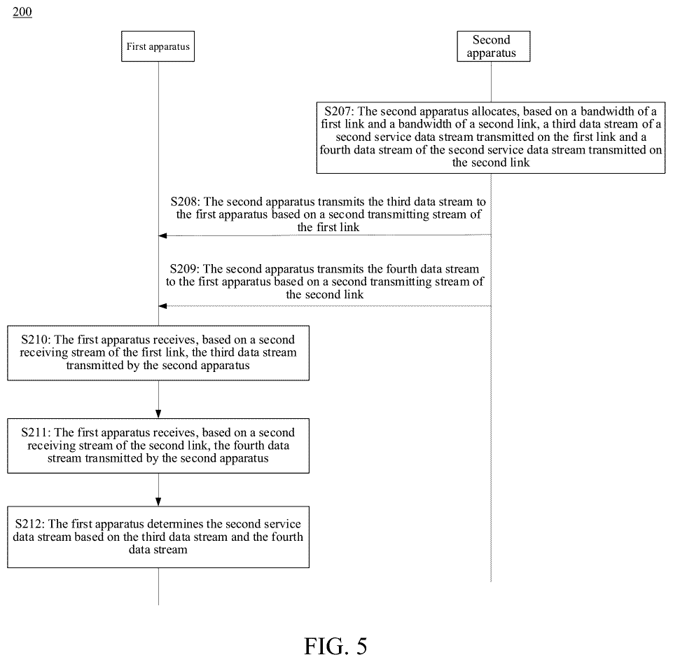

In one embodiment, the second apparatus may also transmit a second service data stream to the first apparatus via the first link and the second link. FIG. 5 is a schematic flowchart of a data transmission method 200 according to an embodiment of this application. The method 200 may alternatively include operations S207 to S212.

S207: The second apparatus allocates, based on a bandwidth of the first link and a bandwidth of the second link, a third data stream of the second service data stream transmitted on the first link and a fourth data stream of the second service data stream transmitted on the second link.

S208: The second apparatus transmits the third data stream to the first apparatus based on a second transmitting stream of the first link.

S209: The second apparatus transmits the fourth data stream to the first apparatus based on a second transmitting stream of the second link.

S210: The first apparatus receives, based on a second receiving stream of the first link, the third data stream transmitted by the second apparatus.

S211: The first apparatus receives, based on a second receiving stream of the second link, the fourth data stream transmitted by the second apparatus.

S212: The first apparatus determines the second service data stream based on the third data stream and the fourth data stream.

As mentioned above, the second transmitting stream of the first link and the second transmitting stream of the second link are used by the second apparatus to transmit data to the first apparatus. Two links, namely the first link and the second link, supporting a QUIC protocol are established between the first apparatus and the second apparatus. The first link includes a first transmitting stream and the second transmitting stream, and the second link also includes a first transmitting stream and the second transmitting stream, so that data can be transmitted to each other between different apparatuses. In addition, the second apparatus may also allocate, based on the bandwidth of the first link and the bandwidth of the second link, the first data stream of the first service data stream transmitted on the first link and the second data stream of the first service data stream transmitted on the second link. As such, data transmission between different apparatuses via a plurality of links is implemented, so that a performance bottleneck of a single physical link can be overcome. In addition, data streams transmitted on different links are allocated based on bandwidths of the links between the different apparatuses, and data streams that need to be transmitted are properly allocated, so that network transmission speed is improved, and user experience is improved.

The foregoing describes a process of how the first apparatus and the second apparatus transmit data between a plurality of QUIC links. The following specifically describes how to establish multiple QUIC paths between the first apparatus and the second apparatus. A method 300 is performed before operation S201.

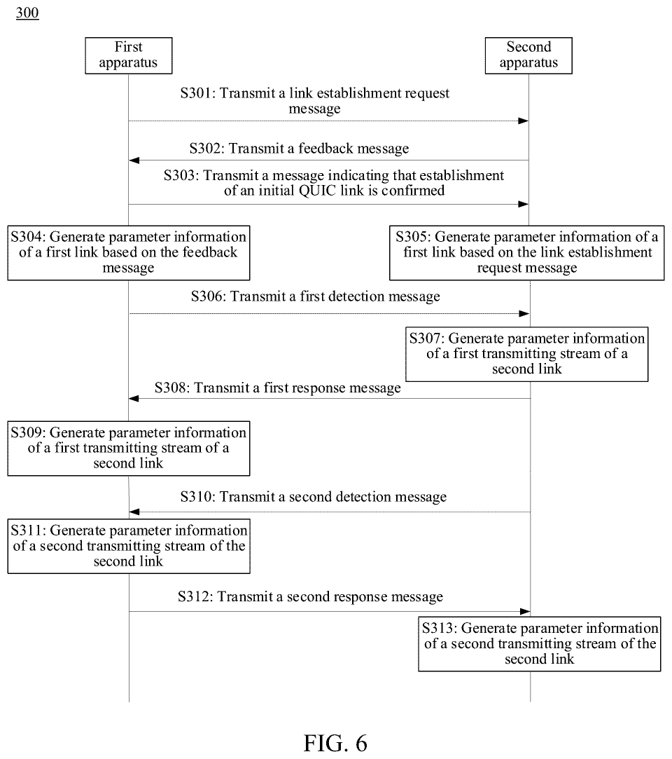

FIG. 6 is a schematic flowchart of a method 300 for establishing multiple QUIC paths according to an embodiment of this application. The method 300 may be performed by any electronic device having a data processing capability. For example, the electronic device may be implemented as a server or a computer. An example in which the electronic device is a first apparatus is used for description. As shown in FIG. 6, the method 300 may include operations S301 to S313.

S301: The first apparatus transmits a request to link message to the second apparatus, the request to link message including a first connection identification, the first connection identification being a connection identification of a first transmitting stream of a first link, and the request to link message further including information indicating whether the first apparatus has a capability supporting QUIC protocol-based multipath and/or a quantity of QUIC protocol-based multipaths supported by the first apparatus.

Correspondingly, the second apparatus receives the request to link message transmitted by the first apparatus.

S302: The second apparatus transmits a feedback message to the first apparatus based on the request to link message, the feedback message including a second connection identification, the second connection identification being a connection identification of a second transmitting stream of the first link, and the feedback message further including information indicating whether the second apparatus has a capability supporting the QUIC protocol-based multipath and/or a quantity of QUIC protocol-based multipaths supported by the second apparatus.

Correspondingly, the first apparatus receives the feedback message transmitted by the second apparatus.

S303: The first apparatus transmits, to the second apparatus, a message indicating that authentication is successful and the establishment of an initial QUIC link is confirmed.

S304: The first apparatus generates parameter information of the first link based on the feedback message, the parameter information of the first link including the first connection identification, the second connection identification, and a link identification of the first link.

S305: The second apparatus generates parameter information of the first link based on the request to link message, the parameter information of the first link including the first connection identification, the second connection identification, and a link identification of the first link.

The first link is a first QUIC link established between the first apparatus and the second apparatus.

When the first apparatus and the second apparatus initially establish a QUIC, the first apparatus may exchange, with the second apparatus, information indicating whether the first apparatus and the second apparatus have their own capabilities supporting the QUIC protocol-based multipath and/or the quantity of QUIC protocol-based multipaths supported by the first apparatus and the second apparatus. To be specific, the request to link message transmitted by the first apparatus to the second apparatus may include the information indicating whether the first apparatus has a capability supporting the QUIC protocol-based multipath and/or the quantity of QUIC protocol-based multipaths supported by the first apparatus, and the feedback message transmitted by the second apparatus to the first apparatus based on the request to link message may include the information indicating whether the second apparatus has a capability supporting the QUIC protocol-based multipath and/or the quantity of the QUIC protocol-based multipaths supported by the second apparatus.

When the first apparatus and the second apparatus initially establish a QUIC, the first apparatus may not exchange, with the second apparatus, the information indicating whether the first apparatus and the second apparatus have their own capabilities supporting the QUIC protocol-based multipath and/or the quantity of QUIC protocol-based multipaths supported by the first apparatus and the second apparatus. In other words, the first apparatus and the second apparatus only establish a single-link QUIC, and the request to link message includes the first connection identification. When the first apparatus detects that the bandwidth of a current transmitting stream and a current transmission rate cannot meet a requirement of a first service, the first apparatus transmits a first message to the second apparatus. The first message includes the information indicating whether the first apparatus has a capability supporting the QUIC protocol-based multipath and/or the quantity of QUIC-based protocol multipaths supported by the first apparatus. The second apparatus receives the first message and transmits a second message to the first apparatus. The second message includes the information indicating whether the second apparatus has a capability supporting the QUIC protocol-based multipath and/or the quantity of QUIC protocol-based multipaths supported by the second apparatus. Then, the first apparatus and the second apparatus negotiate the multiple QUIC paths.

In one embodiment, the request to link message may be a client hello message. The client hello message includes a first public number, and the first public number is used by the second apparatus to generate a communication key. The second apparatus generates the communication key based on a randomly generated private key and the first public number.

In one embodiment, the feedback message may be a reject message. The reject message includes a second public number, and the second public number is a configuration parameter of the second apparatus. The second public number is used by the first apparatus to generate a communication key, and the first apparatus generates the communication key based on a randomly generated private key and the second public number.

Specifically, the client hello message and the reject message are messages transmitted to each other when the first apparatus and the second apparatus initially establish a QUIC, and are mainly configured for verification of the communication parties.

Generally speaking, the QUIC only requires one round-trip time (RTT) to complete the negotiation of the communication key. Certainly, when the first apparatus caches a configuration parameter of the second apparatus, such as the foregoing configuration parameter of the second apparatus, the first apparatus may transmit the client hello message to the second apparatus. The first apparatus calculates the communication key based on the configuration parameter of the second apparatus, encrypts and transmits application data to the second apparatus. The second apparatus calculates the communication key based on the client hello message. In other words, the first apparatus can transmit the application data without a handshake, which is a 0-RTT handshake. For a process of the QUIC negotiating the communication key through one RTT and a process of the QUIC negotiating the communication key through 0 RTT, reference may be made to the existing QUIC process. Details are not described herein again.

The first apparatus may carry, when establishing a QUIC to the second apparatus, the information indicating whether the first apparatus has the capability supporting the QUIC protocol-based multipath and/or the quantity of QUIC protocol-based multipaths supported by the first apparatus. For example, the client hello message includes the information indicating whether the first apparatus has the capability supporting the QUIC protocol-based multipath and/or the quantity of QUIC protocol-based multipaths supported by the first apparatus, the second apparatus receives the client hello message, and the reject message transmitted by the second apparatus to the first apparatus includes the information indicating whether the second apparatus has the capability supporting the QUIC protocol-based multipath and/or the quantity of the QUIC protocol-based multipaths supported by the second apparatus. Alternatively, when the first apparatus and the second apparatus have established the first link, when the first apparatus detects that the bandwidth of the current transmitting stream or the current transmission rate cannot meet the requirement of the first service, the first apparatus may negotiate with the second apparatus to establish the second link, and the first apparatus transmits the first message to the second apparatus. The first message includes the information indicating whether the first apparatus has the capability supporting the QUIC protocol-based multipath and/or the quantity of QUIC protocol-based multipaths supported by the first apparatus. The second apparatus receives the first message and transmits the second message to the first apparatus. The second message includes the information indicating whether the second apparatus has the capability supporting the QUIC protocol-based multipath and/or the quantity of QUIC protocol-based multipaths supported by the second apparatus. Then, the first apparatus establishes the second link with the second apparatus.

The first apparatus transmits, to the second apparatus, the information indicating that the first apparatus has the capability supporting the QUIC protocol-based multipath and/or the quantity of QUIC protocol-based multipaths supported by the first apparatus, and the second apparatus transmits, to the first apparatus, the information indicating that the second apparatus has the capability supporting the QUIC protocol-based multipath and/or the quantity of the QUIC protocol-based multipaths supported by the second apparatus. The first apparatus and the second apparatus obtain the information about a multipath capability supported by the other end. However, the second link is not enabled. Therefore, the following operations are required.

S306: The first apparatus transmits a first detection message to the second apparatus via the second link, the first detection message including a first path detection frame, and the first path detection frame including a third connection identification.

Correspondingly, the second apparatus receives, via the second link, the first detection message transmitted by the first apparatus.

S307: The second apparatus generates parameter information of a first transmitting stream of the second link, the parameter information of the first transmitting stream of the second link including the third connection identification, and a link identification of the second link, and the link identification of the second link being a second link identification.

S308: The second apparatus transmits a first response message to the first apparatus via the second link, the first response message including a first path response frame.

Correspondingly, the first apparatus receives, via the second link, the first response message transmitted by the second apparatus, and the first response message includes a first path response frame.

S309: The first apparatus generates the parameter information of the first transmitting stream of the second link based on the first response message, the parameter information of the first transmitting stream of the second link including the third connection identification and the link identification of the second link.

Specifically, the first apparatus creates the first transmitting stream on the second link. The first apparatus transmits the first path detection frame, such as a PATH_CHALLENGE frame, via the second link. After receiving the PATH_CHALLENGE frame, the second apparatus checks whether multipath is enabled. If the second apparatus enables the multipath, the second apparatus creates the second link and a first receiving stream of the second link. The second apparatus generates parameter information of the first receiving stream of the second link. The parameter information of the first receiving stream of the second link includes the third connection identification and the link identification of the second link. The third connection identification is a connection identification of the first transmitting stream of the second link, and the link identification of the second link is the second link identification. The second apparatus transmits the first response message, such as a PATH_RESPONSE frame, to the first apparatus. After receiving the first response message, the first apparatus generates the parameter information of the first transmitting stream of the second link.

In one embodiment, the second link identification and the first link identification may be represented by numbers that are in successive ascending order. If the first link identification is represented by 1, the second link identification is represented by 2.

At this time, the first apparatus may transmit data to the second apparatus based on the first transmitting stream of the second link, but a reverse data transmission channel is not established, that is, the second apparatus cannot transmit data to the first apparatus, and the following operations are required.

S310: The second apparatus transmits a second detection message to the first apparatus via the second link, the second detection message including a second path detection frame.

Correspondingly, the first apparatus receives, via the second link, the second detection message transmitted by the second apparatus.

S311: The first apparatus generates parameter information of a second transmitting stream of the second link, the parameter information of the second transmitting stream of the second link including a fourth connection identification and the link identification of the second link, the fourth connection identification being a connection identification of the second transmitting stream of the second link, and the link identification of the second link being the second link identification.

S312: The first apparatus transmits a second response message to the second apparatus via the second link, the second response message including a second path response frame.

Correspondingly, the second apparatus receives, via the second link, the second response message transmitted by the first apparatus.

S313: The second apparatus generates the parameter information of the second transmitting stream of the second link based on the second response message, the parameter information of the second transmitting stream of the second link including the fourth connection identification and the link identification of the second link, the fourth connection identification being a connection identification of a transmitting stream of the second link, and the link identification of the second link being the second link identification.

Specifically, the second apparatus creates the second transmitting stream of the second link. The second apparatus transmits the second path detection frame, such as a PATH_CHALLENGE frame, via the second link. After receiving the PATH_CHALLENGE frame, the first apparatus checks whether multipath is enabled. If the first apparatus enables the multipath, the first apparatus creates the second link and a second receiving stream of the second link. The second apparatus generates parameter information of the second receiving stream of the second link. The parameter information of the second receiving stream of the second link includes the fourth connection identification and the link identification of the second link, the fourth connection identification being a connection identification of a transmitting stream of the second link, and the link identification of the second link being the second link identification. The first apparatus transmits the second response message, such as a PATH_RESPONSE frame, to the second apparatus. After receiving the second response message, the second apparatus generates the parameter information of the second transmitting stream of the second link.

The second link is a QUIC link other than the first link between the first apparatus and the second apparatus. The second link may include one link or a plurality of links. If the second link includes the plurality of links, link identifications of the plurality of links may be represented by numbers that are in ascending order. If the link identification of the first link is represented by 1, a link identification of the 1st second link is represented by 2, a link identification of the 2nd second link is represented by 3, and the like.

After the foregoing process, multiple QUIC paths are established between the first apparatus and the second apparatus, and data streams can be transmitted and received between the first apparatus and the second apparatus via the multiple QUIC paths, thereby breaking through a performance bottleneck of a single physical link, improving network transmission speed, and improving user experience.

A complete multipath system also includes functional modules such as path status management, path capability assessment, and data stream packet sending decision. The path status management may include: checking whether a path is active and removing an invalid path. The following separately describes checking whether a path is active and removing invalid paths.

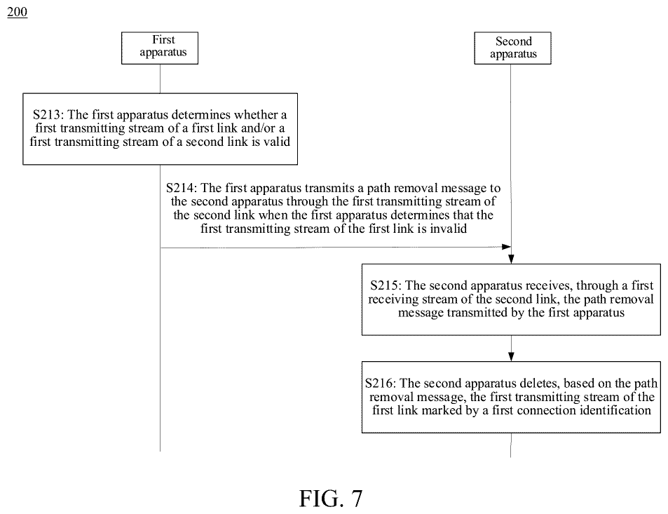

In one embodiment, FIG. 7 is a schematic flowchart of a data transmission method 200 according to an embodiment of this application. The method 200 may further include operations S213 to S216.

S213: The first apparatus determines whether the first transmitting stream of the first link and/or the first transmitting stream of the second link is valid.

S214: The first apparatus transmits a path removal message to the second apparatus through the first transmitting stream of the second link when the first apparatus determines that the first transmitting stream of the first link is invalid, the path removal message including the first connection identification.

S215: The second apparatus receives, through the first receiving stream of the second link, the path removal message transmitted by the first apparatus.

S216: The second apparatus deletes, based on the path removal message, the first transmitting stream of the first link marked by the first connection identification.

In the foregoing operations S213 to S216, the first apparatus transmits the path removal message to the second apparatus through the first transmitting stream of the second link when the first apparatus determines that the first transmitting stream of the first link is invalid. The second apparatus deletes, based on the path removal message, the first transmitting stream of the first link marked by the first connection identification. As such, path status management of a plurality of links is implemented. The second apparatus can avoid, by deleting the connection identification in time, incorrect determining of a status of the first transmitting stream, and a part of a memory can also be reduced.

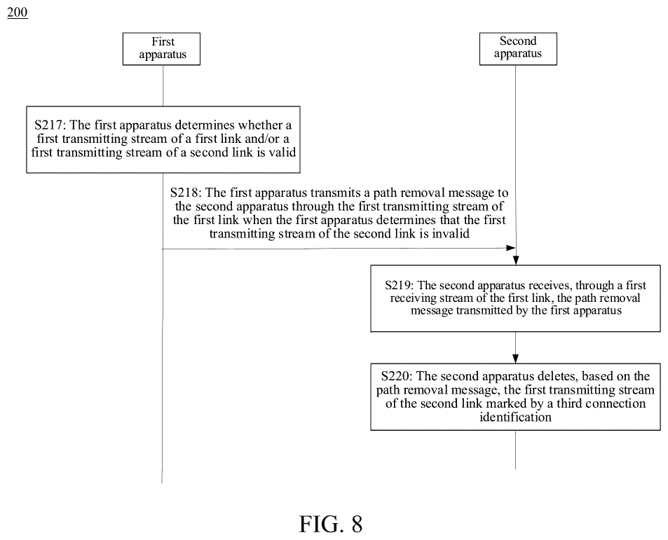

FIG. 8 is a schematic flowchart of a data transmission method 200 according to an embodiment of this application. The method 200 may further include operations S217 to S220.

S217: The first apparatus determines whether the first transmitting stream of the first link and/or the first transmitting stream of the second link is valid.

S218: The first apparatus transmits a path removal message to the second apparatus through the first transmitting stream of the first link when the first apparatus determines that the first transmitting stream of the second link is invalid, the path removal message including the third connection identification.

S219: The second apparatus receives, through the first receiving stream of the first link, the path removal message transmitted by the first apparatus.

S220: The second apparatus deletes, based on the path removal message, the first transmitting stream of the second link marked by the third connection identification.

In the foregoing operations S217 to S220, the first apparatus transmits the path removal message to the second apparatus through the first transmitting stream of the first link when the first apparatus determines that the first transmitting stream of the second link is invalid. The second apparatus deletes, based on the path removal message, the first transmitting stream of the second link marked by the third connection identification. As such, path status management of a plurality of links is implemented. The second apparatus can avoid, by deleting the connection identification in time, incorrect determining of a status of the second transmitting stream, and a part of a memory can also be reduced.

In one embodiment, the first apparatus determines whether the first link is invalid includes the following operations.

The first apparatus transmits a path status detection message to the second apparatus through the first transmitting stream of the first link.

When the first apparatus receives a path status response message transmitted by the second apparatus through a second receiving stream of the first link, it is determined that the first transmitting stream of the first link is valid.

When the first apparatus does not receive a path status response message transmitted by the second apparatus through a second receiving stream of the first link, it is determined that the first transmitting stream of the first link is invalid.

In one embodiment, the path status detection message may be a data packet, and the path status response message may be an acknowledgment (ACK) frame.

In one embodiment, the path status detection message may be a packet Internet groper (PING) frame, and the path status response message may be a PONG frame.

In one embodiment, when detecting whether the first link is valid, the first apparatus may double-check an activity status of a path based on the ACK and PING frames.

Specifically, when data is transmitted through the first transmitting stream of the first link within a preset time period and the ACK frame transmitted by the second apparatus is received, it is considered that the first link is active; otherwise, the PING frame is transmitted through the first transmitting stream of the first link. If the second apparatus can respond to the PONG frame within the preset time period, it is considered that the first link is active; otherwise, the PING frame is continued to be transmitted through the first transmitting stream of the first link (with a sending time interval of 1/2/4/8) for a maximum of five PING frames. If the second apparatus has no response within the preset time period, the first link is invalid. After the path is invalid, path removal is triggered, a PATH_ABANBON frame is transmitted through the first transmitting stream of the second link, the first link identification to be removed is carried, and the second apparatus is notified of removal of the first path.

The second apparatus detects whether the second transmitting stream of the first link and the second transmitting stream of the second link are valid. For a specific detection process, reference may be made to the process of the first apparatus detecting the first transmitting stream of the first link and the first transmitting stream of the second link. This is not described herein again.

The path capability assessment is described below. The path capability assessment includes several parts: path bandwidth assessment, path congestion handling, and the like. The QUIC protocol supports congestion algorithms such as a bottleneck bandwidth and RTT (BBR) algorithm and a CBUIC algorithm (where the CBUIC algorithm is an improved version of the Binary Increase Congestion-Transmission Control Protocol (BIC-TCP)). The first apparatus and the second apparatus may estimate a bandwidth of each path in real time based on the RTT extracted by the congestion algorithm and an amount of data transmitted per unit time. For the first apparatus and the second apparatus extracting, based on the congestion algorithm, the RTT and the amount of data transmitted per unit time, reference may be made to related art. This is not described in this application.

In one embodiment, that the first apparatus allocates, based on a bandwidth of a first link and a bandwidth of a second link, a first data stream of a first service data stream transmitted on the first link and a second data stream of the first service data stream transmitted on the second link includes:
adjusting a transmitting window of the first service data stream based on the bandwidth of the first link and the bandwidth of the second link, the transmitting window including a first sub-window and a second sub-window, the first sub-window corresponding to the transmitting stream of the first link, and the second sub-window corresponding to the transmitting stream of the second link;
transmitting the first data stream via the first link based on the first sub-window; and
transmitting the second data stream via the second link based on the second sub-window.

Specifically, two different physical links, namely the first link and the second link, may be regarded as a logical link, and the logical link is configured to transmit the first service data stream. The logical link corresponds to a transmitting window, and the transmitting window includes the first sub-window and the second sub-window. The first sub-window corresponds to the transmitting stream of the first link, and the second sub-window corresponds to the transmitting stream of the second link. The first sub-window and the second sub-window are dynamically adjusted based on the bandwidth of the first link and the bandwidth of the second link, to dynamically adjust a transmission capability of each path.

In one embodiment, the sizes of initial windows of the first sub-window and the second sub-window are the same.

Specifically, when the first apparatus initially transmits the first service data stream through the first link and the second link and multipath is established initially, the first link evenly divides the transmitting window between the first link and the second link to ensure that each path has an opportunity to transmit stream data.

In one embodiment, the first apparatus estimates the bandwidths of the first link and the second link based on the RTT extracted from a current congestion algorithm and the amount of data transmitted per unit time, and then dynamically adjusts the first sub-window and the second sub-window based on an estimated bandwidth ratio.

According to the foregoing method, a plurality of QUIC physical links is established between devices by applying the QUIC protocol, so as to transmit data, thereby effectively solving the problems of low bandwidth and reduced frame rate caused by a performance bottleneck of a single QUIC physical link, and improving user experience. To show the effect more intuitively, a set of experiments are provided below for description.

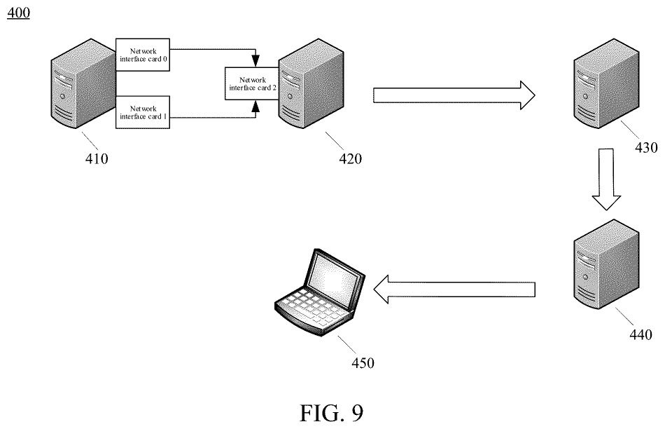

FIG. 9 is an optional schematic diagram of an experimental scenario involved in an embodiment of this application. As shown in FIG. 9, a system architecture 400 includes a server 410, a server 420, a server 430, a server 440, and a user device 450. The server 410 has two network interface cards, namely network interface card 0 and network interface card 1. A speed limiting tool is used to limit the bandwidth capability of a physical link. A bandwidth of network interface card 0 is set to 2.4 Mbps, and a bandwidth of network interface card 1 is set to 1.6 Mbps. The server 420 has one network interface card, namely network interface card 2.

This experiment needs to compare the performance of a single QUIC path and multiple QUIC paths. A RTMP OVER single QUIC path performs stream pushing via a physical link between network interface card 0 of the server 410 and the server 420. The multiple QUIC paths between the server 410 and the server 420 are the first link and the second link that are respectively a physical link between network interface card 0 of the server 410 and network interface card 2 of the server 420 and a physical link between network interface card 1 of the server 410 and network interface card 2 of the server 420. The server 410 performs stream pushing by using a real time messaging protocol (rtmp) over quic tool, and transmits local stream data to the server 420 via the first link and the second link. The server 420 transmits the stream data to the server 430. The server 430 may be a third-party equipment room for providing application data for the user device. The server 430 transmits the received stream data to the server 440. The server 440 may be a service network accessed by a user, and the user device 450 pulls streaming from the server 440 for playing.

During the experiment, the server 410 uses RTMP OVER single QUIC path and the RTMP OVER multiple QUIC paths tools to separately push a stream with a data rate with a bit rate of 3 Mbps and a frame rate of 30 frames. Then, a stream pushing effect is shown on a statistical platform of a live streaming system and a user side for a comparative experiment.

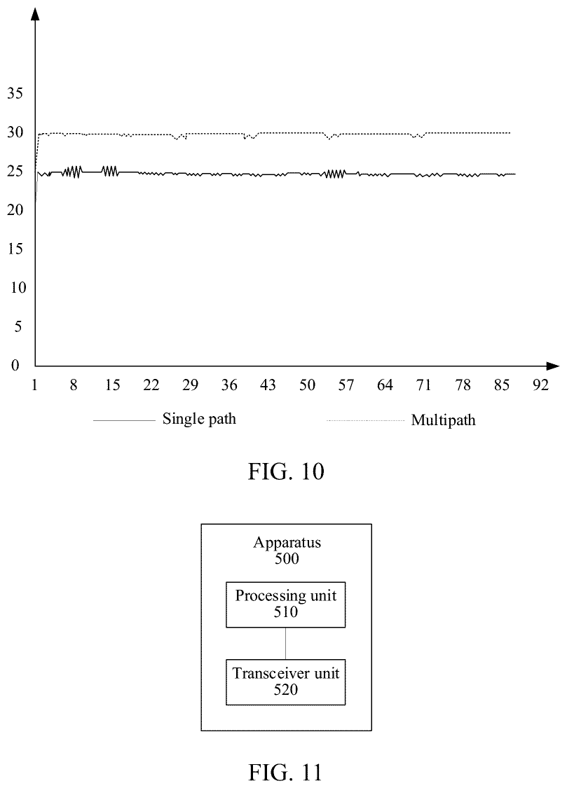

The comparative experiment shows that the RTMP OVER single QUIC path tool is used to push the stream with a data rate of 30 frames and 3 Mbps, an average frame rate calculated on the live streaming platform is about 25 frames, and a screen on an observation side is also occasionally stuck. Using the RTMP OVER multiple QUIC paths tool to push a stream with the bit rate of 30 frames and 3 Mbps, an average frame rate calculated on the live streaming platform is about 30 frames, and a screen on an audience side is smoother. Comparative data is shown in FIG. 10. FIG. 10 is a schematic diagram of link performance parameters of a single QUIC path and multiple QUIC paths according to an embodiment of this application. In FIG. 10, a solid line is the single QUIC path, and a dashed line is the multiple QUIC paths. From the data provided in FIG. 10, it can be learned that in the multiple QUIC paths, capability limitations of a single physical link can be overcome and a better effect is achieved by superimposing capabilities of a plurality of physical links.

Various embodiments of this application are described in detail above with reference to the accompanying drawings. However, this application is not limited to the specific details in the foregoing embodiments, a plurality of simple deformations may be made to the technical solution of this application within a range of the technical concept of this application, and these simple deformations fall within the protection scope of this application. For example, the various specific technical features described in the foregoing embodiments may be combined in any suitable manner without contradiction. To avoid unnecessary repetition, various possible combination manners are not further described in this application. For another example, different embodiments of this application may also be arbitrarily combined without departing from the idea of this application, and these combinations shall still be regarded as content disclosed in this application.

In various method embodiments of this application, sequence numbers of the foregoing processes do not indicate an execution sequence, and execution sequences of the processes shall be determined based on functions and internal logic of the processes, and shall not be constructed as any limitation on the implementation processes of embodiments of this application. These numbers may be interchanged where appropriate, so that embodiments of this application described can be implemented in sequences other than those illustrated or described.

The method embodiments of this application are described in detail above with reference to FIG. 1 to FIG. 10, and the apparatus embodiments of this application are described in detail below with reference to FIG. 11 to FIG. 13.

FIG. 11 is a schematic block diagram of an apparatus 500 according to an embodiment of this application. The apparatus 500 can implement the functions of the first apparatus in the foregoing method. As shown in FIG. 11, the apparatus 500 includes a processing unit 510 and a transceiver unit 520.

The processing unit 510 is configured to allocate, based on a bandwidth of a first link and a bandwidth of a second link, a first data stream of a first service data stream transmitted on the first link and a second data stream of the first service data stream transmitted on the second link,
the first link and the second link connecting the first apparatus and a second apparatus, a physical address of the first apparatus corresponding to the first link being different from a physical address of the first apparatus corresponding to the second link, and the first link and the second link being links supporting a quick user datagram protocol Internet connection (QUIC) protocol.

The transceiver unit 520 is configured to transmit the first data stream to the second apparatus based on a transmitting stream of the first link.

The transceiver unit 520 is further configured to transmit the second data stream to the second apparatus based on a transmitting stream of the second link.

In some embodiments, before the allocating, based on a bandwidth of a first link and a bandwidth of a second link, a first data stream of a first service data stream transmitted on the first link and a second data stream of the first service data stream transmitted on the second link, the transceiver unit 520 is further configured to:
transmit a request to link message to the second apparatus, the request to link message including a first connection identification, the first connection identification being a connection identification of the transmitting stream of the first link, and the request to link message further including information indicating whether the first apparatus has a capability supporting QUIC protocol-based multipath and/or a quantity of QUIC protocol-based multipaths supported by the first apparatus; and
receive a feedback message transmitted by the second apparatus, the feedback message including a second connection identification, the second connection identification being a connection identification of a second transmitting stream of the first link, and the feedback message further including information indicating whether the second apparatus has a capability supporting the QUIC protocol-based multipath and/or a quantity of QUIC protocol-based multipaths supported by the second apparatus.

The processing unit 510 is further configured to:

generate parameter information of the first link based on the feedback message, the parameter information of the first link including the first connection identification, the second connection identification, and a link identification of the first link, and the link identification of the first link being a first link identification.

In some embodiments, the transceiver unit 520 is further configured to:
transmit a first detection message to the second apparatus via the second link, the first detection message including a first path detection frame; and
receive, via the second link, a first response message transmitted by the second apparatus, the first response message including a first path response frame.

The processing unit 510 is further configured to:
generate parameter information of the transmitting stream of the second link based on the first response message, the parameter information of the transmitting stream of the second link including a third connection identification and a link identification of the second link, the third connection identification being a connection identification of the transmitting stream of the second link, and the link identification of the second link being a second link identification.

In some embodiments, the transceiver unit 520 is further configured to:
receive, via the second link, a second detection message transmitted by the second
apparatus, the second detection message including a second path detection frame; and
transmit a second response message to the second apparatus via the second link, the second response message including a second path response frame.

In some embodiments, the transceiver unit 520 is further configured to:
transmit a path removal message to the second apparatus through a first transmitting
stream of the second link when a first transmitting stream of the first link is invalid, the path removal message including the first connection identification; or
transmit a path removal message to the second apparatus through a first transmitting stream of the first link when the first transmitting stream of the second link is invalid, the path removal message including the third connection identification.

In some embodiments, the processing unit 510 is specifically configured to:
adjust a transmitting window of the first service data stream based on the bandwidth of the first link and the bandwidth of the second link, the transmitting window including a first sub-window and a second sub-window, the first sub-window corresponding to the transmitting stream of the first link, and the second sub-window corresponding to the transmitting stream of the second link.

The transceiver unit 520 is further configured to:
transmit the first data stream via the first link based on the first sub-window; and
transmit the second data stream via the second link based on the second sub-window.

In some embodiments, the transceiver unit 520 is further configured to:
receive, based on a receiving stream of the first link, a third data stream transmitted by the second apparatus; and
receive, based on a receiving stream of the second link, a fourth data stream transmitted by the second apparatus.

The processing unit 510 is further configured to:
determine a second service data stream based on the third data stream and the fourth data stream.

In some embodiments, a physical address of the second apparatus corresponding to the first link is different from a physical address of the second apparatus corresponding to the second link.

The apparatus embodiments and the method embodiments may correspond to each other, for similar descriptions, reference may be made to the method embodiments. To avoid repetition, details are not described herein again. Specifically, when the apparatus 500 in this embodiment may correspond to the execution entity of the method 200 or method 300 of embodiments of this application, the foregoing and other operations and/or functions of each module in the apparatus 500 are respectively for implementing the corresponding processes of the first apparatus in the foregoing method 200 and method 300. For brevity, details are not described herein again.

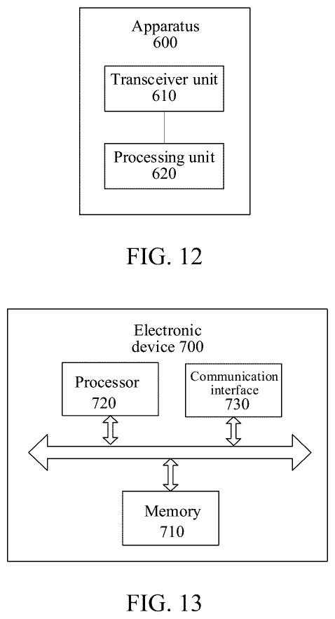

FIG. 12 is a schematic block diagram of an apparatus 600 according to an embodiment of this application. The apparatus 600 can implement the functions of the second apparatus in the foregoing method. As shown in FIG. 12, the apparatus 600 may include a transceiver unit 610 and a processing unit 620.

The transceiver unit 610 is configured to receive, based on a receiving stream of a first link, a first data stream transmitted by a first apparatus.

The transceiver unit 610 is further configured to receive, based on a receiving stream of a second link, a second data stream transmitted by the first apparatus.

The first link and the second link are links for connection between the first apparatus and the second apparatus, a physical address of the first apparatus corresponding to the first link is different from a physical address of the first apparatus corresponding to the second link, and the first link and the second link are links supporting a quick user datagram protocol Internet connection (QUIC) protocol.

The processing unit 620 is configured to determine a first service data stream based on the first data stream and the second data stream.

In some embodiments, before the receiving, based on a first receiving stream of a first link, a first data stream transmitted by a first apparatus, the transceiver unit 610 is further configured to:
receive a request to link message transmitted by the first apparatus, the request to link message including a first connection identification, the first connection identification being a connection identification of a transmitting stream of the first link, and the request to link message further including information indicating whether the first apparatus has a capability supporting QUIC protocol-based multipath and/or a quantity of QUIC protocol-based multipaths supported by the first apparatus; and
transmit a feedback message to the first apparatus based on the request to link message, the feedback message including a second connection identification, the second connection identification being a connection identification of the receiving stream of the first link, and the feedback message further including information indicating whether the second apparatus has a capability supporting the QUIC protocol-based multipath and/or a quantity of QUIC protocol-based multipaths supported by the second apparatus.

The processing unit 620 is further configured to:
generate parameter information of the first link, the parameter information of the first link including the first connection identification, the second connection identification, and a link identification of the first link, and the link identification of the first link being a first link identification.

In some embodiments, the transceiver unit 610 is further configured to: receive, via the second link, a first detection message transmitted by the first apparatus, the first detection message including a first path detection frame; and

transmit a first response message to the first apparatus via the second link, the first response message including a first path response frame.

In some embodiments, the transceiver unit 610 is further configured to:
transmit a second detection message to the first apparatus via the second link, the second detection message including a second path detection frame; and
receive, via the second link, a second response message transmitted by the first apparatus, the second response message including a second path response frame.

The processing unit 620 is further configured to:
generate parameter information of a transmitting stream of the second link based on the second response message, the parameter information of the transmitting stream of the second link including a fourth connection identification and a link identification of the second link, the fourth connection identification being a connection identification of a transmitting stream of the second link, and the link identification of the second link being a second link identification.

In some embodiments, the transceiver unit 610 is further configured to:
transmit a path removal message to the first apparatus through the transmitting stream of the second link when the transmitting stream of the first link is invalid, the path removal message including the first link identification; or
transmit a path removal message to the first apparatus through the transmitting stream of the first link when the transmitting stream of the second link is invalid, the path removal message including the second link identification.

In some embodiments, the processing unit 620 is further configured to:
allocate, based on a bandwidth of the first link and a bandwidth of the second link, a
third data stream of a second service data stream transmitted on the first link and a fourth data stream of the second service data stream transmitted on the second link.

The transceiver unit 610 is further configured to:
transmit the third data stream to the first apparatus based on the transmitting stream of the first link; and
transmit the fourth data stream to the first apparatus based on the transmitting stream of the second link.

In some embodiments, a physical address of the second apparatus corresponding to the first link is different from a physical address of the second apparatus corresponding to the second link.

The apparatus embodiments and the method embodiments may correspond to each other, for similar descriptions, reference may be made to the method embodiments. To avoid repetition, details are not described herein again. Specifically, when the apparatus 600 in this embodiment may correspond to the execution entity of the method 200 or method 300 of embodiments of this application, the foregoing and other operations and/or functions of each module in the apparatus 600 are respectively for implementing the corresponding processes of the second apparatus in the foregoing method 200 and method 300. For brevity, details are not described herein again.

The foregoing describes the apparatus and system in embodiments of this application from the perspective of a functional module with reference to the accompanying drawings. The functional module may be implemented in the form of hardware, or an instruction in the form of software, or in the form of a combination of hardware and software modules. Specifically, the operations in the method embodiments in embodiments of this application may be completed by a hardware integrated logic circuit in a processor and/or an instruction in the form of software. The operations of the method disclosed with reference to embodiments of this application may be directly performed and completed by using a hardware decoding processor, or may be performed and completed by using a combination of hardware and software modules in the decoding processor. In one embodiment, the software module may be stored in a storage medium that is mature in the art, such as a random access memory, a flash memory, a read-only memory, a programmable read-only memory, an electrically erasable programmable memory, or a register. The storage medium is located in the memory. The processor reads information in the memory and completes the operations in the method embodiments in combination with hardware thereof.

FIG. 13 is a schematic block diagram of an electronic device 700 according to an embodiment of this application.

As shown in FIG. 13, the electronic device 700 may include:
a memory 710 and a processor 720. The memory 710 is configured to store a computer program, and transmit the computer program to the processor 720. In other words, the processor 720 may call and run the computer program from the memory 710, to implement the method in embodiments of this application.

For example, the processor 720 may be configured to perform the operations of each execution entity in the foregoing method 200 and method 300 based on instructions in the computer program.

In some embodiments of this application, the processor 720 may include but is not limited to:
a general-purpose processor, a digital signal processor (DSP), an application-specific integrated circuit (ASIC), a field-programmable gate array (FPGA), or another programmable logic device, a discrete gate or a transistor logic device, a discrete hardware component, or the like.

In some embodiments of this application, the memory 710 includes but is not limited to:
a volatile memory and/or a non-volatile memory. The non-volatile memory may be a read-only memory (ROM), a programmable ROM (PROM), an erasable PROM (EPROM), an electrical EPROM (EEPROM), or a flash memory. The volatile memory may be a random access memory (RAM) serving as an external cache. Through illustrative but not limited description, RAMs in many forms, for example, a static RAM (SRAM), a dynamic RAM (DRAM), a synchronous DRAM (SDRAM), a double data rate SDRAM (DDR SDRAM), an enhanced SDRAM (ESDRAM), a synchlink DRAM (SLDRAM), and a direct rambus RAM (DRRAM), are available.

In some embodiments of this application, the computer program may be divided into one or more modules. The one or more modules are stored in the memory 710 and executed by the processor 720 to perform the method provided in this application. The one or more modules may be a series of computer program instruction segments capable of completing particular functions, and the instruction segments are configured to describe an execution process of the computer program in the electronic device 700.

In one embodiment, the electronic device 700 may further include:
a communication interface 730, where the communication interface 730 may be connected to the processor 720 or the memory 710.

The processor 720 may control the communication interface 730 to communicate with other devices, specifically, to transmit information or data to other devices, or to receive information or data transmitted by other devices. For example, the communication interface 730 may include a transmitter and a receiver. The communication interface 730 may further include an antenna, and a quantity of antennas may be one or more.

Various components in the electronic device 700 are connected via a bus system. In addition to a data bus, the bus system further includes a power bus, a control bus, and a status signal bus.

According to one aspect of this application, a communication apparatus is provided and includes a processor and a memory. The memory is configured to store a computer program. The processor is configured to call and run the computer program stored in the memory, so that the processor performs the method in the foregoing method embodiments.

According to one aspect of this application, a computer storage medium is provided. The computer storage medium has a computer program stored thereon, and when the computer program is executed by a computer, the computer is enabled to perform the method in the foregoing method embodiments. Alternatively, an embodiment of this application further provides a computer program product including instructions, and when the instructions are executed by a computer, the computer is enabled to perform the method in the foregoing method embodiments.

According to another aspect of this application, a computer program product or a computer program is provided. The computer program product or computer program includes computer instructions, and the computer instructions are stored in a computer-readable storage medium. A processor of a computer device reads the computer instructions from the computer-readable storage medium, and the processor executes the computer instructions, so that the computer device performs the method in the foregoing method embodiments.

In other words, when software is used to implement embodiments, all or some of embodiments may be implemented in the form of a computer program product. The computer program product includes one or more computer instructions. When the computer instructions are loaded and executed on a computer, all or some of procedures or functions according to embodiments of this application are generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from one website, computer, server, or data center to another website, computer, server, or data center in a wired (for example, a coaxial cable, an optical fiber, or a digital subscriber line (DSL)) or wireless (for example, infrared, radio, or microwave) manner. The computer-readable storage medium may be any usable medium accessible by the computer, or a data storage device, for example, a server or a data center, integrating one or more usable media. The usable medium may be a magnetic medium (such as a floppy disk, a hard disk, or a magnetic tape), an optical medium (such as a digital video disc (DVD)), a semiconductor medium (such as a solid-state drive (SSD)), or the like.

In embodiments of this application, “B corresponding to A” indicates that B is associated with A. In one embodiment, B may be determined based on A. Determining A based on B does not mean that B is only determined based on A, and B may be alternatively determined based on A and/or other information.

In addition, in the descriptions of this application, unless otherwise specified, “at least one” means one or more, and “a plurality of” means two or more. In addition, “and/or” describes an association relationship between associated objects and represents that three relationships may exist. For example, A and/or B may represent: Only A exists, both A and B exist, and only B exists. A and B may be singular or plural. The character “/” generally indicates an “or” relationship between the associated objects. “At least one of the following items (pieces)” or a similar expression means any combination of these items (pieces), including a single item (piece) or any combination of a plurality of items (pieces). For example, at least one item (piece) of a, b, or c may indicate a, b, c, a-b, a-c, b-c, or a-b-c, where a, b, and c may be singular or plural.

The descriptions such as first and second, appearing in embodiments of this application are only used for illustration and distinction of described objects. There is no order, nor do the descriptions indicate any special limitation on a quantity of devices in embodiments of this application, and cannot constitute any limitation on embodiments of this application.

Particular features, structures, or characteristics related to embodiments are included in at least one embodiment of this application. In addition, these particular features, structures, or characteristics may be combined in one or more embodiments in any proper manner.

Moreover, the terms “include”, “have” and any other variants are intended to cover the non-exclusive inclusion, for example, a process, method, system, product, or server that includes a list of operations or units is not necessarily limited to those expressly listed operations or units, but may include other operations or units not expressly listed or inherent to such a process, method, product, or device.

In the one embodiment consistent with the present disclosure, related possible data such as user information is involved. In a case that the foregoing embodiments of this application are applied to a specific product or technology, a permission or consent of a user is required, and collection, use, and processing of the related data need to comply with relevant laws, regulations, and standards of relevant countries and regions.

A person of ordinary skill in the art may be aware that modules and algorithm operations described with reference to the examples described in embodiments disclosed in this specification can be implemented by electronic hardware or a combination of computer software and electronic hardware. Whether the functions are executed in a manner of hardware or software depends on particular applications and design constraint conditions of the technical solutions. A person skilled in the art may use different methods to implement the described functions for each particular application, but it shall not be considered that the implementation goes beyond the scope of this application.

In the embodiments provided in this application, the disclosed device, apparatus, and method may be implemented in other manners. For example, the foregoing described apparatus embodiments are merely exemplary. For example, the module division is merely a logical function division and may be other divisions in various embodiments. For example, a plurality of modules or components may be combined or integrated into another system, or some features may be ignored or not performed. In addition, the displayed or discussed mutual couplings or direct couplings or communication connections may be implemented through some interfaces. The indirect couplings or communication connections between the apparatuses or modules may be implemented in electronic, mechanical, or other forms.

The modules described as separate parts may or may not be physically separate, and the parts displayed as modules may or may not be physical modules, may be located in one position, or may be distributed on a plurality of network units. Some or all of the modules may be selected according to certain needs to achieve the objectives of the solutions of embodiments. For example, functional modules in embodiments of this application may be integrated into one processing module, or each of the modules may exist alone physically, or two or more modules may be integrated into one module.

The foregoing descriptions are merely embodiments of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

What is claimed is:

1. A data transmission method, applied to a first apparatus, the method comprising:
allocating, based on a bandwidth of a first link corresponding to a first physical address of the first apparatus, and a bandwidth of a second link corresponding to a second physical address of the first apparatus, a first data stream of a first service data stream transmitted on the first link and a second data stream of the first service data stream transmitted on the second link, wherein
the first link and the second link being links of a quick user datagram protocol Internet connection (QUIC) protocol;
transmitting the first data stream from the first apparatus to the second apparatus based on a first transmitting stream of the first link; and
transmitting the second data stream from the first apparatus to the second apparatus based on a first transmitting stream of the second link.

2. The method according to claim 1, wherein before the allocating, based on the bandwidth of a first link and the bandwidth of a second link, a first data stream of a first service data stream transmitted on the first link and a second data stream of the first service data stream transmitted on the second link, the method further comprises:
transmitting a request to link message to the second apparatus, the request to link message comprising a first connection identification, the first connection identification being a connection identification of the first transmitting stream of the first link, and the request to link message further comprising information indicating whether the first apparatus has capability to support QUIC protocol-based multipath and/or a quantity of QUIC protocol-based multipaths supported by the first apparatus;
receiving a feedback message transmitted by the second apparatus, the feedback message comprising a second connection identification, the second connection identification being a connection identification of a second transmitting stream of the first link, and the feedback message further comprising information indicating whether the second apparatus has capability to support the QUIC protocol-based multipath and/or a quantity of QUIC protocol-based multipaths supported by the second apparatus; and
generating parameter information of the first link based on the feedback message, the parameter information of the first link comprising the first connection identification, the second connection identification, and a link identification of the first link, and the link identification of the first link being a first link identification.

3. The method according to claim 2, further comprising:
transmitting a first detection message to the second apparatus via the second link, the first detection message comprising a first path detection frame;
receiving, via the second link, a first response message transmitted by the second apparatus, the first response message comprising a first path response frame; and
generating parameter information of the first transmitting stream of the second link based on the first response message, the parameter information of the first transmitting stream of the second link comprising a third connection identification and a link identification of the second link, the third connection identification being a connection identification of the first transmitting stream of the second link, and the link identification of the second link being a second link identification.

4. The method according to claim 2, further comprising:
receiving, via the second link, a second detection message transmitted by the second apparatus, the second detection message comprising a second path detection frame; and
transmitting a second response message to the second apparatus via the second link, the second response message comprising a second path response frame.

5. The method according to claim 3, further comprising:
transmitting a path removal message to the second apparatus through the first transmitting stream of the second link when the first transmitting stream of the first link is invalid, the path removal message comprising the first connection identification; or
transmitting a path removal message to the second apparatus through the first transmitting stream of the first link when the first transmitting stream of the second link is invalid, the path removal message comprising the third connection identification, and the third connection identification being the connection identification of the first transmitting stream of the second link.

6. The method according to claim 1, wherein the allocating, based on the bandwidth of a first link and the bandwidth of a second link, a first data stream of a first service data stream transmitted on the first link and a second data stream of the first service data stream transmitted on the second link comprises:
adjusting a transmitting window of the first service data stream based on the bandwidth of the first link and the bandwidth of the second link, the transmitting window comprising a first sub-window and a second sub-window, the first sub-window corresponding to a transmitting stream of the first link, and the second sub-window corresponding to a transmitting stream of the second link;
transmitting the first data stream through the first transmitting stream of the first link based on the first sub-window; and
transmitting the second data stream through the first transmitting stream of the second link based on the second sub-window.

7. The method according to claim 1, further comprising:
receiving, through a first receiving stream of the first link, a third data stream transmitted by the second apparatus;
receiving, through a first receiving stream of the second link, a fourth data stream transmitted by the second apparatus; and
determining a second service data stream based on the third data stream and the fourth data stream.

8. The method according to claim 1, wherein a physical address of the second apparatus corresponding to the first link is different from a physical address of the second apparatus corresponding to the second link.

9. A data transmission method, applied to a second apparatus, the method comprising:
receiving, based on a first receiving stream of a first link, a first data stream transmitted by a first apparatus, the first link corresponding to a first physical address of the first apparatus;
receiving, based on a first receiving stream of a second link, a second data stream transmitted by the first apparatus, the second link corresponding to a second physical address of the first apparatus, and the first link and the second link being links supporting a quick user datagram protocol Internet connection (QUIC) protocol; and
determining a first service data stream based on the first data stream and the second data stream.

10. The method according to claim 9, wherein before the receiving, based on a first receiving stream of a first link, a first data stream transmitted by a first apparatus, the method further comprises:
receiving a request to link message transmitted by the first apparatus, the request to link message comprising a first connection identification, the first connection identification being a connection identification of a transmitting stream of the first link, and the request to link message further comprising information indicating whether the first apparatus has a capability supporting QUIC protocol-based multipath and/or a quantity of QUIC protocol-based multipaths supported by the first apparatus;
transmitting a feedback message to the first apparatus based on the request to link message, the feedback message comprising a second connection identification, the second connection identification being a connection identification of a receiving stream of the first link, and the feedback message further comprising information indicating whether the second apparatus has a capability supporting the QUIC protocol-based multipath and/or a quantity of QUIC protocol-based multipaths supported by the second apparatus; and
generating parameter information of the first link, the parameter information of the first link comprising the first connection identification, the second connection identification, and a link identification of the first link, and the link identification of the first link being a first link identification.

11. The method according to claim 10, further comprising:
receiving, via the second link, a first detection message transmitted by the first apparatus, the first detection message comprising a first path detection frame; and
transmitting a first response message to the first apparatus via the second link, the first response message comprising a first path response frame.

12. The method according to claim 10, further comprising:
transmitting a second detection message to the first apparatus via the second link, the second detection message comprising a second path detection frame;
receiving, via the second link, a second response message transmitted by the first apparatus, the second response message comprising a second path response frame; and
generating parameter information of a second transmitting stream of the second link based on the second response message, the parameter information of the first transmitting stream of the second link comprising a fourth connection identification and a link identification of the second link, the fourth connection identification being a connection identification of a transmitting stream of the second link, and the link identification of the second link being a second link identification.

13. The method according to claim 11, further comprising:
receiving, through the first receiving stream of the second link, a path removal message transmitted by the first apparatus, the path removal message comprising the first connection identification; or
receiving, through the first receiving stream of the first link, a path removal message transmitted by the first apparatus, the path removal message comprising a third connection identification; and
deleting a first transmitting stream of the first link or the first transmitting stream of the second link based on the path removal message.

14. The method according to claim 9, further comprising:
allocating, based on a bandwidth of the first link and a bandwidth of the second link, a third data stream of a second service data stream transmitted on the first link and a fourth data stream of the second service data stream transmitted on the second link;
transmitting the third data stream to the first apparatus based on the transmitting stream of the first link; and
transmitting the fourth data stream to the first apparatus based on the transmitting stream of the second link.

15. The method according to claim 9, wherein a physical address of the second apparatus corresponding to the first link is different from a physical address of the second apparatus corresponding to the second link.

16. A method for establishing multiple quick user datagram protocol Internet connection (QUIC) paths, applied to a first apparatus, the method comprising:
transmitting a request to link message to a second apparatus, the request to link message comprising a first connection identification, the first connection identification being a connection identification of a first transmitting stream of a first link, and the request to link message further comprising information indicating whether the first apparatus has a capability supporting QUIC protocol-based multipath and/or a quantity of QUIC protocol-based multipaths supported by the first apparatus;
receiving a feedback message transmitted by the second apparatus, the feedback message comprising a second connection identification, the second connection identification being a connection identification of a second transmitting stream of the first link, and the feedback message further comprising information indicating whether the second apparatus has a capability supporting the QUIC protocol-based multipath and/or a quantity of QUIC protocol-based multipaths supported by the second apparatus; and
generating parameter information of the first link based on the feedback message, the parameter information of the first link comprising the first connection identification, the second connection identification, and a link identification of the first link, and the link identification of the first link being a first link identification.

17. The method according to claim 16, further comprising:
transmitting a first detection message to the second apparatus via a second link, the first detection message comprising a first path detection frame;
receiving, via the second link, a first response message transmitted by the second apparatus, the first response message comprising a first path response frame; and
generating parameter information of a transmitting stream of the second link based on the first response message, the parameter information of the transmitting stream of the second link comprising a third connection identification and a link identification of the second link, the third connection identification being a connection identification of a first transmitting stream of the second link, and the link identification of the second link being a second link identification.

18. The method according to claim 16, further comprising:
receiving, via the second link, a second detection message transmitted by the second apparatus, the second detection message comprising a second path detection frame; and
transmitting a second response message to the second apparatus via the second link, the second response message comprising a second path response frame.

19. The method according to claim 18, further comprising:
allocating, based on a bandwidth of the first link that corresponds to a first physical address of the first apparatus, and a bandwidth of the second link that corresponds to a second physical address of the first apparatus, a first data stream of a first service data stream transmitted on the first link and a second data stream of the first service data stream transmitted on the second link, the first link and the second link being links supporting a quick user datagram protocol Internet connection (QUIC) protocol;
transmitting the first data stream to the second apparatus based on the first transmitting stream of the first link; and
transmitting the second data stream to the second apparatus based on the first transmitting stream of the second link.

20. An electronic device, comprising a processor and a memory, the memory having instructions stored therein, and the instructions, when being run by the processor, causing the processor to perform the method according to claim 16.
